(19) United States
(12) Patent Application Publication
(10) Pub. No.: US 2026/0371085 A1
(43) Pub. Date: Nov. 19, 2026

(54) HISTORY BASED AUTHENTICATION IN WIRELESS NETWORKS

(71) Applicant: Sequans Communications SA, Colombes (FR)

(72) Inventors: Prasidh Ramabadran, Reading (GB); Thomas Winiecki, Reading (GB); Efstathios Katranaras, Sofia (BG)

(21) Appl. No.: 19/210,658

(22) Filed: May 16, 2025

(51) Int. Cl. H04W 12/069

(52) U.S. Cl. CPC H04W 12/069

(57) ABSTRACT

Disclosed are example embodiments of a method for authenticating a UE. A base station may receive an attach request from the UE that includes a base station identity check including a request for an encrypted version of historical wireless connection parameters. The base station may generate a first encrypted version based on one or more historical wireless connection parameters previously shared with the UE. An authentication request that includes the first encrypted version may be generated and sent to the UE. The UE may verify it and generate a second encrypted version based on additional historical parameters. A response code may also be generated at the UE. The UE may transmit an authentication response. The base station may receive the response and validate the second encrypted version. The base station may also validate the response code using a locally computed value. Based on these validations, the UE may be authenticated.

### TECHNICAL FIELD

The present disclosure relates generally to wireless network security, and more specifically, some embodiments relate to systems and methods for authentication in wireless communications using encrypted representations of historical connection data, e.g., to mitigate one or more of spoofing, denial-of-service attacks, and unauthorized access by adversarial nodes.

### BACKGROUND

Wireless communication systems rely on authentication protocols to establish trust between user devices and network infrastructure. During the initial connection, user equipment (UE) typically transmits identifiers and participates in a challenge-response sequence to verify identity and enable secure communication. These protocols play a critical role in protecting sensitive data and preventing unauthorized access.

However, modern wireless environments face increasing challenges from adversarial actors. For example, unauthorized nodes may attempt to intercept or spoof control signals, impersonate legitimate infrastructure, or trigger repeated authentication failures to disrupt service. These threats are especially concerning in systems where identifiers must be transmitted openly to initiate authentication.

Enhancing the robustness of authentication—particularly in the presence of potentially malicious intermediaries—remains an important goal. Improvements that leverage context-specific information or device history, without exposing sensitive data during transmission, may offer promising paths forward.

### SUMMARY

Disclosed are example embodiments of a method for authenticating a user equipment (UE) in a wireless network. A base station may receive an attach request from the UE that includes a base station identity check, where the identity check includes a request for an encrypted version of historical wireless connection parameters shared between the UE and the wireless network. The base station may generate a first encrypted version based on one or more historical wireless connection parameters previously shared with the UE during earlier wireless connections. An authentication request that includes the first encrypted version may be generated and sent to the UE. The UE may verify the first encrypted version using locally stored historical data and, upon successful verification, may generate a second encrypted version based on additional historical parameters. A response code may also be generated at the UE based on a shared secret authentication value. The UE may transmit an authentication response that includes the second encrypted version and the response code. The base station may receive the response and validate the second encrypted version by comparing it with its own stored historical data. The base station may also validate the response code using a locally computed value. Based on these validations, the UE may be authenticated for wireless communication.

Disclosed are example embodiments of a system for secure wireless authentication. The system includes a base station having one or more processors and a memory storing instructions that, when executed, perform authentication operations. The system may receive an attach request from a UE that includes a base station identity check referencing historical wireless connection parameters shared between the UE and the wireless network. The system may generate a first encrypted version using one or more historical wireless connection parameters previously shared with the UE during earlier connections. An authentication request that includes the first encrypted version may be constructed and transmitted to the UE. The base station may receive an authentication response including a second encrypted version of additional historical wireless connection parameters and a response code based on a shared secret authentication value. The second encrypted version may be validated against locally stored historical data, and the response code may be validated using a locally computed value. The UE may be authenticated for wireless communication based on both validations.

Disclosed are example embodiments of a method performed by a user equipment (UE) for authenticating with a wireless network. The UE may transmit an attach request to a base station that includes a base station identity check, where the check requests an encrypted version of historical wireless connection parameters shared between the UE and the wireless network. An authentication request may be received from the base station, the challenge includes a first encrypted version based on historical parameters associated with the UE. The UE may retrieve locally stored historical wireless connection parameters and verify the received hash using those values. In response to a successful verification, the UE may generate a second encrypted version of additional historical wireless connection parameters, and a response code based on a shared secret authentication value. An authentication response containing the second encrypted version and the response code may be sent to the base station. The UE may participate in session establishment based on the successful authentication.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a diagram illustrating an example of a wireless communication system including user equipment (UE), a base station, and a core network, in which history-based wireless authentication may be deployed.

FIG. 2 is a diagram illustrating an example communication flow between a UE and a base station using cryptographic hashes of historical wireless connection parameters for authentication.

FIG. 3 is a diagram illustrating an example timeline of challenge-response authentication exchanges using hashed historical data during a wireless connection establishment process.

FIG. 4 illustrates a generalized authentication process used in conventional cellular communication systems.

FIG. 5 illustrates an enhanced authentication process using cryptographically hashed history data exchanged between a user device and a base station in accordance with the systems and methods described herein.

FIGS. 6A-6B form a flow chart illustrating an example method for authenticating a UE in a wireless network using cryptographic hashes of historical wireless connection parameters.

FIG. 7 is a block diagram illustrating an example of a base station hardware architecture configured for performing history-based wireless authentication.

FIG. 8 is a block diagram illustrating an example of a UE hardware architecture configured for performing history-based wireless authentication.

FIGS. 9A-9B form a flow chart illustrating an example method performed by a UE for participating in history-based wireless authentication with a base station.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable, similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Disclosed are example embodiments of methods for authenticating a user equipment (UE) in a wireless network. In one embodiment, the method includes receiving, at a base station, an attach request from the UE. The attach request includes an identity check for the base station, where an encrypted version of one or more historical wireless connection parameters with the infrastructure is generated at the UE. The method includes transmission of the attach request together with infrastructure identity check from the UE. The method further includes receiving at the base station, the attach request and the identity check query. The method further includes generating, at the base station, the first encrypted version sought by the UE that was queried for identity check, generating a second encrypted version of one or more historical wireless connection parameters with the UE. The method includes transmitting an authentication request comprising the first encrypted version, query for the second encrypted version and a standard secret code-based challenge. The method further includes receiving the authentication request at the UE, verifying the first hash transmitted by the base station. If the first encrypted version is verified successfully, the method further includes an authentication response and completion of identification. If the first encrypted version is not verified successfully, the connection is terminated. The method for generating authentication response includes generating the second encrypted version of historical events sought by the base station, generating the code-based response sought by the base station. The method further includes at the UE, transmitting the authentication response. The method also includes receiving, at the base station, the authentication response from the UE. The method further includes validating, at the base station, the response based on a comparison of the second encrypted version with locally stored historical data, validating the response code based on the code computed locally and authenticating the UE for wireless communication based on the validation.

Embodiments of the systems, methods, and devices described herein enable enhanced wireless authentication by leveraging cryptographically encoded historical connection data as an additional factor in verifying the identity of UE. These embodiments are particularly suited for modern cellular and wireless communication systems, such as 4G Long Term Evolution (LTE), 5G New Radio (NR), and future wireless protocols, where conventional identifier-based authentication methods may be vulnerable to spoofing, replay attacks, and denial-of-service (DoS) threats. By incorporating mutually known wireless session history into the authentication process, the disclosed techniques strengthen the resilience of access procedures and improve trust between network infrastructure and mobile devices without compromising user privacy.

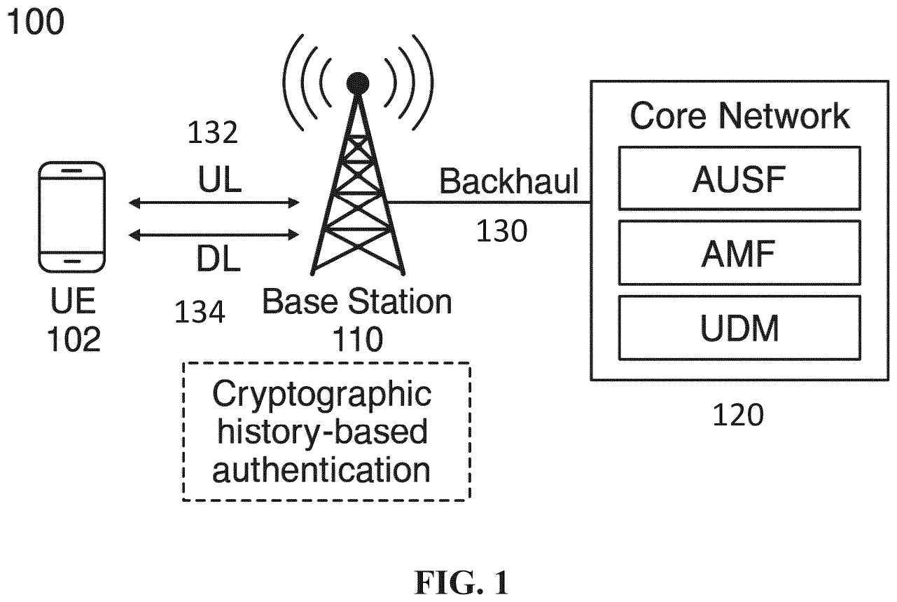

FIG. 1 is a diagram illustrating an example of a wireless communications system 100 capable of implementing history-based wireless authentication. The wireless communications system includes a UE 102, one or more base stations 110, and a core network 120. Base stations 110 may include a disaggregated or monolithic architecture and may communicate directly with the core network 120 over a backhaul link 130. In some embodiments, the base stations 110 may be configured for cryptographic history-based authentication as described herein.

Base station 110 may comprise one or more distributed units (DUs) and/or centralized units (CUs), communicating with radio units (RUs) that provide radio frequency (RF) links to UEs 102 via uplink (UL) wireless transmissions 132 and downlink (DL) wireless transmissions 134. UE 102 may initiate a connection request to base station 110, which may trigger an authentication procedure enhanced by cryptographic hashing of historical wireless connection parameters (or an encrypted version of historical wireless connection parameters in some embodiments), such as previous Cell IDs, Channel Quality Indicator (CQI) values, timestamps, or modulation and coding schemes used in past sessions.

The core network 120 may include various functional entities, such as an Authentication Server Function (AUSF), an Access and Mobility Management Function (AMF), and a Unified Data Management (UDM) server, which collectively manage registration, mobility, and authentication of UEs 102. However, the history-based authentication described herein is primarily performed locally between UE 102 and the base station 110 prior to or concurrently with conventional network authentication flows, thereby providing an additional layer of security against spoofing and replay attacks.

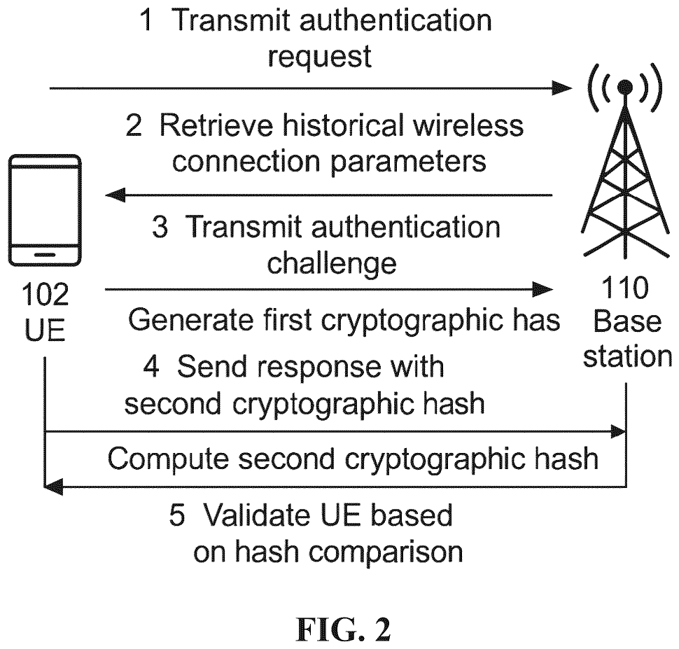

FIG. 2 is a diagram illustrating an example of an authentication exchange 200 between a UE 102 and a base station 110 using historical wireless connection parameters. At step 1, the UE 102 transmits an attach request to base station 110. At step 2, the base station 110 retrieves one or more previously recorded wireless connection parameters associated with the UE 102, such as a previously observed Cell ID, a prior CQI report, or a timestamp of a prior session.

At step 3, the base station 110 generates a first cryptographic hash value based on the selected historical data and transmits an authentication request containing the hash to the UE 102. At step 4, the UE 102 computes a second cryptographic hash using its locally stored historical data corresponding to the requested parameters and sends a response including the second hash to the base station 110. At step 5, the base station 110 validates the UE 102 by verifying that the received hash matches the expected value based on its own records. If validation is successful, UE 102 is authenticated for further wireless communication. Otherwise, access is denied, or a fallback procedure is initiated.

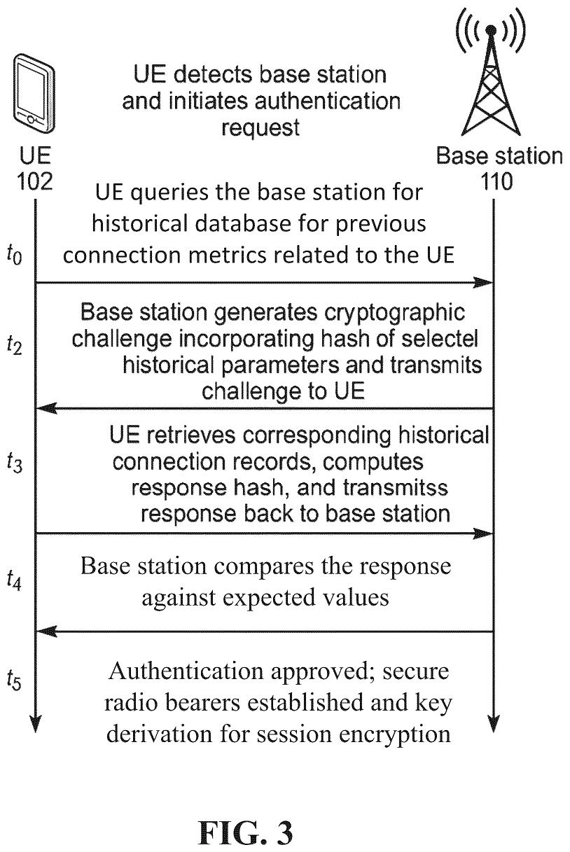

FIG. 3 is a diagram illustrating an example timeline of authentication events 300 using history-based validation. At time t₀, the UE queries the base station for historical database for previous connection metrics related to the UE. At time t₁, the base station queries its historical database for previous connection metrics related to the UE. At time t₂, the base station generates a cryptographic challenge incorporating a hash of selected historical parameters and transmits the challenge to the UE.

At time t₃, the UE retrieves its corresponding historical connection records, computes a response hash, and transmits the response back to the base station. At time t₄, the base station compares the response against expected values. A successful match leads to authentication approval at time t₅, enabling establishment of secure radio bearers and key derivation for session encryption. Failure to authenticate may trigger additional verification mechanisms or session rejection.

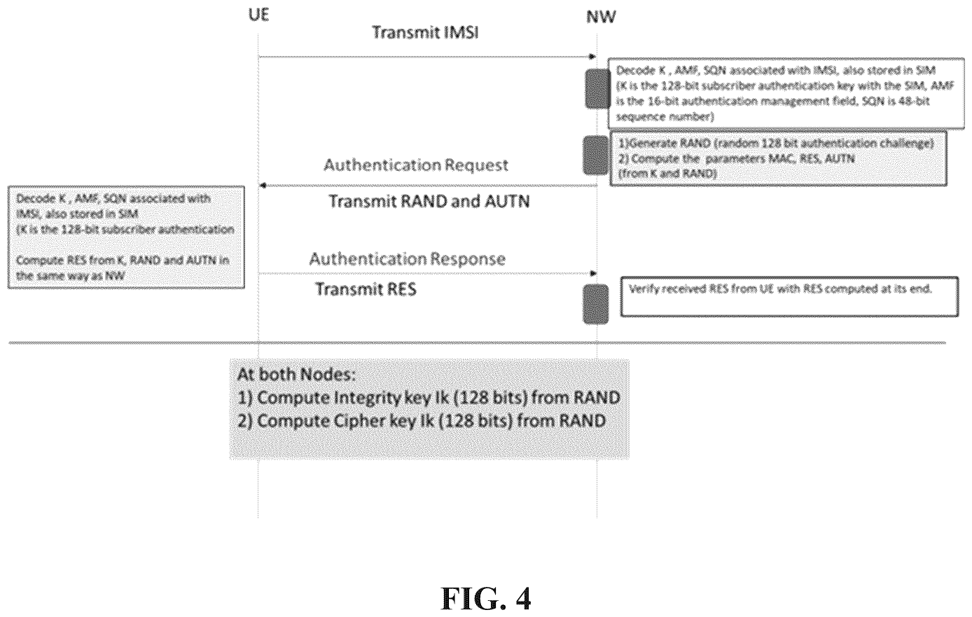

FIG. 4 illustrates a generalized authentication process used in conventional cellular communication systems. In such systems, user authentication typically begins when a UE senses a reference signal from a base station (BS) and initiates an access request by transmitting its International Mobile Subscriber Identity (IMSI). Each IMSI is linked to a long-term secret key, denoted as ‘K’. Upon receiving the IMSI, the base station generates a random number (RAND) and computes an authentication token (AUTN) using bitwise operations with the key K. This authentication request, which may include RAND and AUTN, may be transmitted back to the UE. The UE processes the challenge using its stored copy of K to compute a response value (RES) and transmits this response to the network. If the computed RES matches the expected value, the UE is authenticated. Simultaneously, the UE verifies AUTN to confirm the legitimacy of the BS. However, this conventional process exposes the IMSI over the air and is susceptible to various attacks, including man-in-the-middle interception, spoofing, and IMSI catching. Sophisticated interceptors may exploit this vulnerability to impersonate a base station, intentionally trigger repeated authentication failures, or cause denial-of-service (DOS) by forcing fallback to weaker communication standards. Although improvements such as time-based rejection mechanisms have been introduced in 5G NR to detect delays indicative of spoofing, the conventional authentication process remains vulnerable to adversaries who can observe the UE across multiple connection attempts.

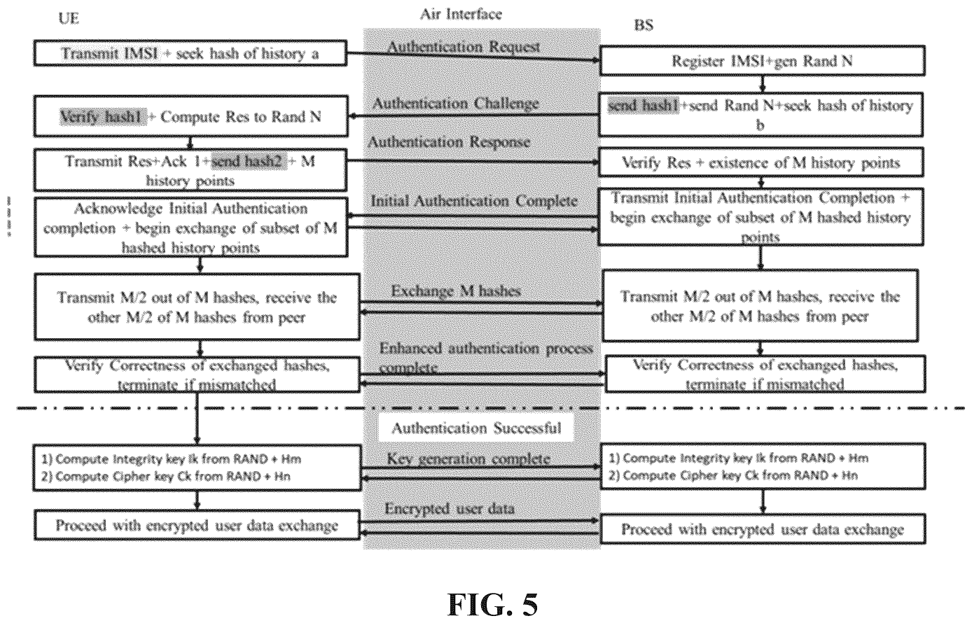

FIG. 5 illustrates an enhanced authentication process using cryptographically hashed history data exchanged between a user device and a base station in accordance with the systems and methods described herein. In one example implementation, the proposed scheme strengthens the authentication process by incorporating a multi-factor mechanism based on mutually known historical events. Such events may include, but are not limited to: the Cell ID previously associated with the UE, time stamps of prior connections, Visitor Location Register (VLR) entries, device identifiers from past sessions, Modulation and Coding Schemes (MCS) used in prior links, Channel Quality Indicators (CQIs) reported for specific time slots, the date of device certification, and RF carrier frequencies used in recent sessions. Any subset or combination of these parameters may be hashed and exchanged as part of the authentication dialogue.

In some embodiments, the historical connection parameters may further include entries from a Visitor Location Register (VLR), such as identifiers associated with temporary roaming profiles, mobile switching center (MSC) locations, or prior handover events. These values may provide additional entropy and session continuity across geographically distributed deployments. Further, the proposed authentication techniques may be deployed in environments supporting multi-mode devices or network fallback scenarios, such as transitions from 5G NR to 4G LTE or 3G Universal Mobile Telecommunications System (UMTS). In such configurations, history-based authentication may be performed independently of protocol fallback to maintain continuity of security posture even when conventional authentication methods become vulnerable during transitions between network generations.

The authentication begins in a conventional manner with the UE transmitting its IMSI to request access. However, in parallel, the UE or BS issues a challenge by requesting a hash of one or more historical data points. For example, a UE may request that the BS return a cryptographic hash of a specific sequence—such as the combination of a time stamp, a past CQI report, and a VLR entry—where only a legitimate BS that shared the original data could compute the correct hash. Upon receiving this hash (h1), the UE may validate its accuracy and proceeds only if the result matches the expected value.

In a complementary embodiment, the authentication flow may be initiated by the UE rather than the base station. Specifically, the UE may transmit a history-based challenge to the base station by requesting a hash of one or more selected historical parameters. The base station, upon receiving this request, retrieves the relevant parameters from local secure storage, computes a cryptographic hash, and returns the result to the UE. The UE then verifies whether the hash matches a locally computed reference value based on its stored history. Only upon successful verification does the UE proceed with responding to the base station's conventional or history-based challenge. This bidirectional exchange enables mutual authentication by requiring that both devices possess aligned, verifiable historical context.

The BS then performs the conventional authentication request using K, RAND, and AUTN, while also requesting a hash of another set of shared historical values. The UE responds with the computed RES along with the requested hash. The BS verifies both the RES and the hash to complete the initial authentication. For enhanced security, the BS and UE may also run a symmetric algorithm to select and hash multiple additional historical parameters, then exchange and verify these hashes. If all values match, the connection proceeds; if not, the session is terminated.

The use of cryptographic hashing provides strong protection, as hashes are computationally infeasible to reverse and highly sensitive to even minor changes in input. For example, a SHA-512 hash of “Sequans” produces a radically different output than the hash of “Sequant,” even though only a single character differs. This ensures that only nodes with precise, mutually known history can authenticate each other successfully.

To further harden the link-layer security, the computed hashes may be incorporated into key generation. For instance, an integrity key (Ik) may be derived from a combination of RAND and a selected hash (Hm), while a cipher key (Ck) may be derived from RAND and another hash (Hn). In this way, encryption keys become session-specific and dependent on recent device activity, thereby mitigating replay attacks.

Additionally, optional enhancements may be applied to physical layer encryption. In one embodiment, modulation symbols may be scrambled by applying modular offsets. For example, in a 16-QAM modulation scheme (QAM-Quadrature Amplitude Modulation), each 4-bit symbol could be offset by one of sixteen possible values, thereby encrypting the transmitted symbol stream. In Orthogonal Frequency-Division Multiplexing (OFDM) systems, sub-carrier assignments may also be dynamically scrambled using secondary keys derived from the hash exchange, increasing the complexity of unauthorized decryption.

By leveraging historical data as a shared authentication factor and integrating it into key generation and physical-layer encryption, the disclosed systems and methods significantly enhance wireless network security, mitigate spoofing and IMSI interception, and resist denial-of-service attacks in environments vulnerable to adversarial interference.

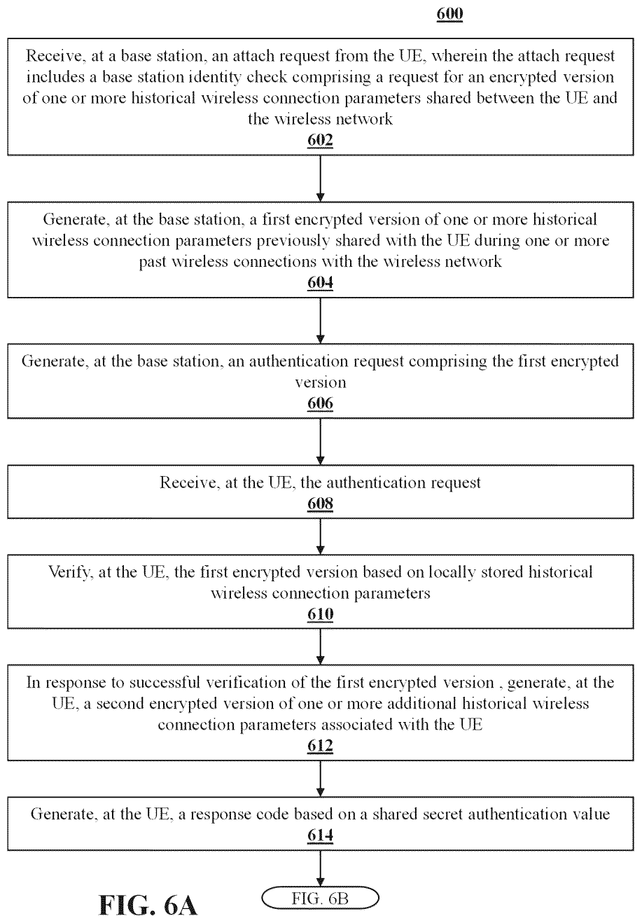

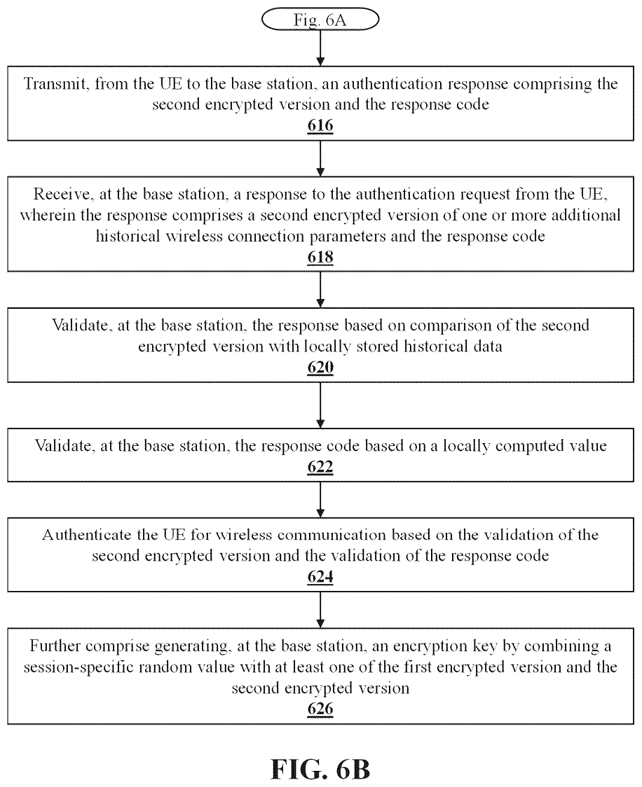

FIG. 6A-6B are flow charts illustrating an example method for authenticating a UE in a wireless network using cryptographic hashes of historical wireless connection parameters and mutual identity checks.

FIG. 6A-6B collectively depict a flow chart 600 illustrating an example method for authenticating a UE using cryptographic hashes of historical wireless connection parameters. The method 600 may be performed collaboratively by a base station and a UE and enhances wireless authentication security by incorporating mutual verification based on shared historical data and secret values. The steps of the method are described below.

At step 602, the base station receives an attach request from a UE. The attach request includes a base station identity check comprising a request for a cryptographic hash of one or more historical wireless connection parameters previously shared between the UE and the wireless network during one or more past wireless connections. This initiates the mutual authentication protocol.

At step 604, the base station generates a first cryptographic hash of the historical wireless connection parameters that were previously shared with the UE. These may include values such as Cell IDs, CQIs, timestamps, handover logs, or MCS indicators observed during prior sessions.

At step 606, the base station generates an authentication request that includes the first cryptographic hash and a request for one or more additional historical parameters from the UE. The challenge may optionally include a random session value or metadata describing the selected historical parameter set.

At step 608, the base station transmits the authentication request to the UE over a downlink control channel. This marks the start of active challenge-response processing. The authentication request may be received at the UE from the downlink control channel. For example, the UE may receive the authentication request and retrieves the relevant locally stored historical wireless connection parameters.

At step 614, the UE verifies the first cryptographic hash based on its own copy of the historical wireless parameters. If the hash matches, the base station is confirmed to possess aligned history and is provisionally authenticated.

At step 616, in response to successful verification of the first hash, the UE generates a second cryptographic hash based on one or more additional historical wireless connection parameters.

At a step 614, the UE generates a response code derived from a shared secret authentication value.

At step 616, the UE transmits an authentication response comprising the second cryptographic hash and the response code to the base station over an uplink control channel.

At step 618, the base station receives the authentication response from the UE, including the second cryptographic hash and the response code.

At step 620, the base station validates the second cryptographic hash by comparing it to a locally generated reference based on stored historical parameters. This determines whether the UE has a valid shared session history.

At step 622, the base station validates the response code using a locally computed secret-based value. Both the hash and the response code may validate for the UE to be considered authenticated.

At step 624, the base station authenticates the UE for wireless communication based on successful validation of both the second cryptographic hash and the response code. This may involve updating access permissions or initiating secure session setup.

At optional step 626, the base station generates a session-specific encryption key by combining a session-specific random value (e.g., RAND) with one or both of the validated cryptographic hashes. The encryption key may be used for secure bearer setup or link-layer scrambling.

The operations in FIG. 6A-6B naturally divide between two entities. The UE initiates the mutual check by requesting identity validation from the base station and performs local cryptographic operations to verify received hashes and generate its own. The base station performs challenge generation, dual validation, and session authentication.

The substeps of each main step may include signal decoding, parameter serialization, hash computation using Secure Hash Algorithm 256-bit (SHA-256), Secure Hash Algorithm 512-bit (SHA-512), Hash-Based Message Authentication Code (HMAC), or BLAKE 3, and secure transmission of messages encoded within existing or proprietary authentication protocols. Encryption keys may also be passed to hardware-level security modules for bearer setup.

In this approach, both UE and base station may demonstrate shared historical context, increasing resistance to spoofing and impersonation attacks without requiring transmission of raw sensitive identifiers. In some embodiments, a cryptographic hash of the shared historical context may serve as a form of multi-factor authentication to establish a secure connection with the network.

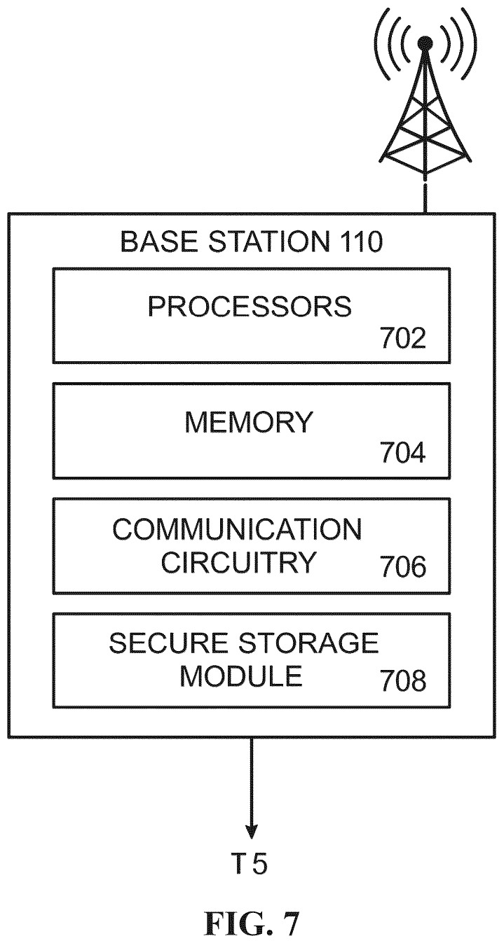

FIG. 7 is a block diagram 700 illustrating an example of a base station 110 configured to implement history-based wireless authentication. Base station 110 includes one or more processors 702, memory 704, communication circuitry 706, and a secure storage module 708.

The processors 702 execute authentication logic stored in memory 704, including operations to retrieve historical wireless connection parameters, compute cryptographic hashes, and validate incoming authentication responses from UEs. The communication circuitry 706 enables radio-frequency transmission and reception with UEs, supporting protocols such as 5G NR, LTE, or other cellular standards. The secure storage module 708 maintains tamper-resistant records of historical UE connection metrics, such as Cell IDs, CQIs, timestamps, and prior session identifiers.

In some embodiments, the base station 110 may dynamically update the stored historical records upon successful authentication events and may escalate authentication requirements (e.g., demand additional history proofs) based on detected anomalies or security policies.

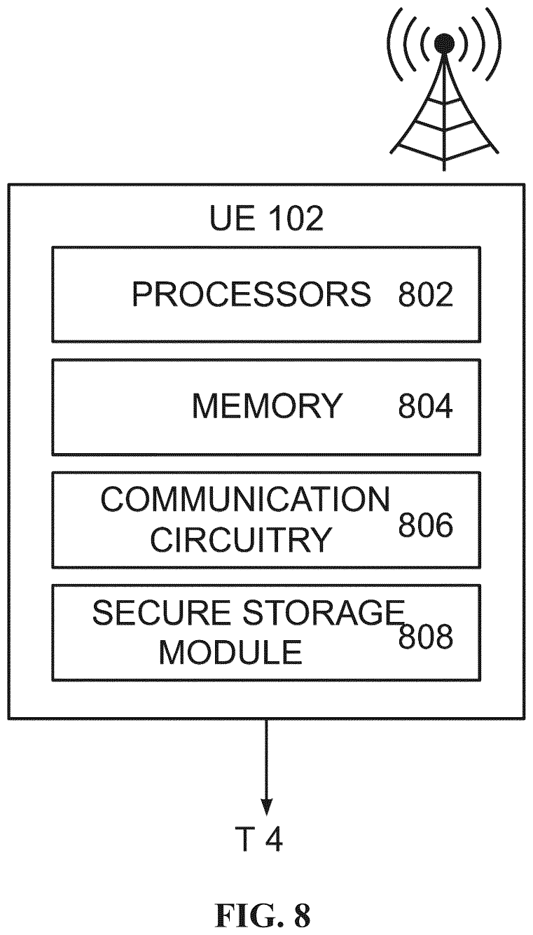

FIG. 8 is a block diagram 800 illustrating an example of a UE 102 configured to perform history-based authentication with a base station. UE 102 includes one or more processors 802, memory 804, communication circuitry 806, and a secure storage module 808.

Processors 802 execute logic stored in memory 804 that allows the UE to execute logic that performs operations including enhanced authentication protocols, including retrieval of locally stored historical parameters, computation of cryptographic hash responses, and validation of base station challenges. The communication circuitry 806 supports wireless transmission and reception over one or more radio access technologies.

The secure storage module 808 preserves historical wireless connection metrics used for authentication, such as prior Cell IDs, CQIs, timestamps, and radio bearer identifiers. Secure storage may be physically integrated with a subscriber identity module (SIM) or embedded SIM (eSIM) for enhanced security. In some embodiments, the UE 800 may additionally use the validated historical hashes to participate in generation of session-specific encryption keys for secure data transmission.

In various implementations, the attach request transmitted by the UE may take the form of a connection initiation message, session establishment request, or a security negotiation trigger. The authentication request generated by the base station may similarly be referred to as a token-based challenge, handshake initiation payload, or parameter proof request, depending on protocol stack level and vendor-specific terminology. These challenges may be encoded in existing control plane messages or encapsulated within custom authentication containers designed to integrate with 3rd Generation Partnership Project (3GPP) or proprietary signaling procedures.

The tamper-evident log referenced herein may be embodied as a secure memory region with hardware-backed integrity, a blockchain-like append-only record, an immutable audit buffer, or a cryptographically signed register of session history. The log may be maintained in volatile or non-volatile storage and may leverage Trusted Platform Module (TPM), Secure Enclave, or similar embedded hardware to detect and prevent unauthorized modifications.

The security profile of the UE, as referenced in connection with dynamic authentication policy adjustments, may include a cumulative trust score, a historical threat vector classification, a record of failed or successful authentications, or a behavior-based risk assessment value. In some embodiments, these profiles may be computed locally by the base station or maintained in a centralized user trust management system across the network.

The symmetric selection algorithm used to determine which historical connection parameters are hashed and exchanged may include deterministic schemes based on shared keys or timestamps, hash-based selection trees, rotating parameter schedules, or negotiated parameter sets using secure random number generators. These algorithms ensure that both the base station and UE arrive at identical selections without prior explicit communication, thus enabling stateless mutual parameter identification for authentication.

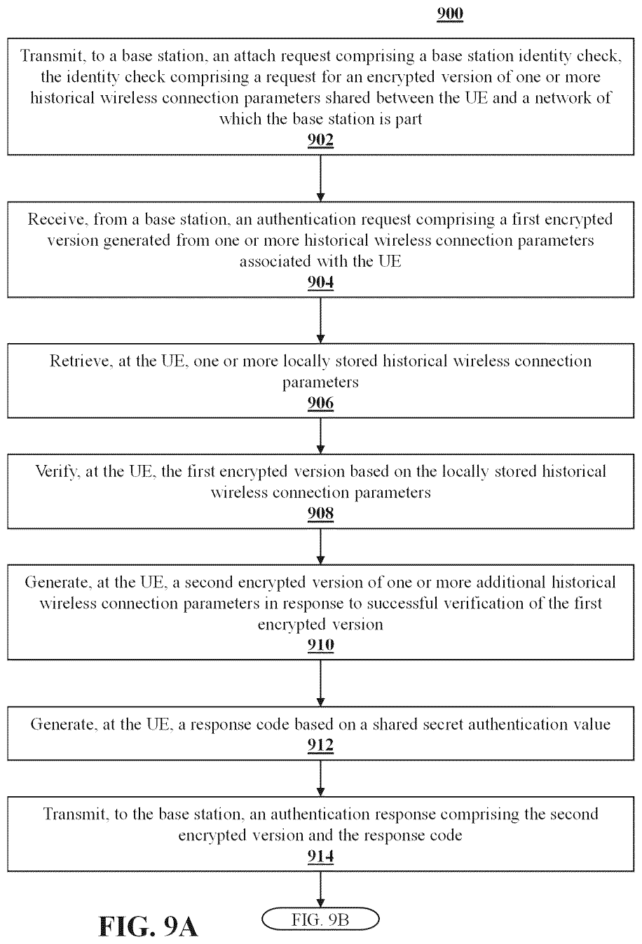

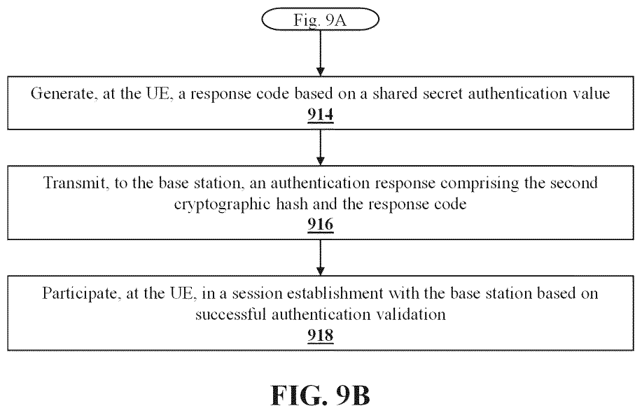

As discussed above, FIG. 6A-6B is a flow chart illustrating an example method for authenticating a UE in a wireless network using cryptographic hashes of historical wireless connection parameters. FIGS. 9A-9B form a flow chart 900 illustrating an example method performed by a UE for authenticating with a wireless network using cryptographic hashes of historical wireless connection parameters. The method 900 includes a sequence of operations executed by the UE in response to an authentication flow initiated by the UE and supported by a base station.

At step 902, the UE transmits an attach request to the base station. This step may include the following substeps: (a) detecting a nearby base station and initiating connection procedures; (b) formatting an attach request message in accordance with LTE or 5G NR standards; (c) generating an identity check comprising a request for a cryptographic hash of historical wireless connection parameters shared with the base station; and (d) transmitting the attach request and identity check over the uplink control channel.

At step 904, the UE receives an authentication request from the base station. This step may include: (a) monitoring a downlink control channel for the authentication request message; (b) decoding the message to extract a first cryptographic hash and any associated metadata; and (c) validating the format and structure of the received message.

At step 906, the UE retrieves one or more locally stored historical wireless connection parameters that correspond to the parameters referenced in the received challenge. These may include: (a) Cell IDs from prior associations; (b) CQI values reported during earlier connections; (c) timestamps of previous sessions; (d) MCS levels used in uplink or downlink; and (e) RF carrier frequencies or temporary IDs.

At step 908, the UE

At step 910, the UE may verify the first cryptographic hash by performing: (a) computing a reference hash locally using the retrieved historical connection parameters; (b) comparing the locally computed hash to the received first cryptographic hash; and (c) terminating the authentication if the hashes do not match.

At step 912, in response to successful verification, the UE generates a second cryptographic hash. This step may include: (a) selecting one or more additional historical wireless connection parameters; (b) serializing or formatting the selected parameters; and (c) computing a second cryptographic hash using a secure hash function (e.g., SHA-512, SHA-3, BLAKE3).

At step 914, the UE generates a response code based on a shared secret authentication value, including: (a) retrieving the stored secret value (e.g., key K); (b) combining the secret with a random challenge or timestamp; and (c) computing the response code via HMAC or symmetric encryption routines.

At step 916, the UE transmits an authentication response to the base station. This step includes: (a) constructing a response message containing the second cryptographic hash and the response code; (b) optionally including message integrity protection (e.g., MAC tag); and (c) transmitting the response to the base station over an uplink channel.

At step 918, the UE participates in session establishment with the base station, assuming successful authentication. This may include: (a) receiving confirmation of authentication from the base station; (b) exchanging or confirming encryption keys for radio bearer setup; (c) enabling ciphering and integrity protection for ongoing communication; and (d) optionally logging session metadata in secure storage.

In various implementations, the UE may perform optional enhancements such as digital signatures, anti-replay timestamp validation, or negotiation of fallback authentication in case of partial failure. The method described enables mutual authentication and integrity assurance based on shared wireless history without exposing long-term identifiers.

In some embodiments, the systems described herein may include one or more computing devices, such as a server, a base station, a router, a network node, or UE. Each computing device may include one or more processors, and one or more memories coupled to the processors.

The processor may be a general-purpose central processing unit (CPU), a graphics processing unit (GPU), a digital signal processor (DSP), an application-specific integrated circuit (ASIC), a field-programmable gate array (FPGA), or another type of electronic circuitry capable of executing software instructions.

The memory may include volatile memory (e.g., random-access memory (RAM)) and/or non-volatile memory (e.g., read-only memory (ROM), flash memory, magnetic storage). The memory may store executable instructions, configuration data, or operational parameters that, when executed or accessed by the processor, cause the computing device to perform one or more of the functions described herein.

In particular, the memory may store instructions that, when executed by the processor, cause the computing device to perform authentication procedures, cryptographic operations, historical data management, communication exchanges, encryption key generation, and other tasks described in this disclosure.

It should be noted that embodiments of the systems and methods described herein may be compatible with standardized wireless protocols, such as those defined by the 3GPP, including LTE and 5G NR. In some implementations, the disclosed techniques may be adapted for use in conjunction with existing authentication frameworks or signaling flows defined in 3GPP releases without requiring changes to core infrastructure. As such, certain embodiments may be suitable for consideration as standard-essential patent (SEP) contributions to relevant telecommunications specifications.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments only by way of illustration. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present disclosure has been presented for the purposes of illustration and description. It is not intended to be exhaustive or to limit the present invention to the precise form disclosed. Many modifications and variations are possible in light of the above teaching. The scope of the present disclosure is defined by the claims. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method for authenticating a user equipment (UE) in a wireless network, comprising:
receiving, at a base station, an attach request from the UE, wherein the attach request includes a base station identity check comprising a request for an encrypted version of one or more historical wireless connection parameters shared between the UE and the wireless network;
generating, at the base station, a first encrypted version of one or more historical wireless connection parameters previously shared with the UE during one or more past wireless connections with the wireless network;
generating, at the base station, an authentication request comprising the first encrypted version ;
receiving, at the UE, the authentication request;
verifying, at the UE, the first encrypted version based on locally stored historical wireless connection parameters;
in response to successful verification of the first encrypted version, generating, at the UE, a second encrypted version of one or more additional historical wireless connection parameters associated with the UE;
generating, at the UE, a response code based on a shared secret authentication value;
transmitting, from the UE to the base station, an authentication response comprising the second encrypted version and the response code;
receiving, at the base station, a response to the authentication request from the UE, wherein the response comprises a second encrypted version of one or more additional historical wireless connection parameters and the response code;
validating, at the base station, the response based on comparison of the second encrypted version with locally stored historical data;
validating, at the base station, the response code based on a locally computed value; and
authenticating the UE for wireless communication based on the validation of the second encrypted version and the validation of the response code.

2. The method of claim 1, wherein the historical wireless connection parameters comprise one or more of:
a previously associated Cell ID,
a timestamp of a network connection,
a recorded Channel Quality Indicator (CQI),
a Modulation and Coding Scheme (MCS), or
a frequency of a previously used RF carrier.

3. The method of claim 1, further comprising generating, at the base station, an encryption key by combining a session-specific random value with at least one of the first encrypted version and the second encrypted version.

4. The method of claim 3, wherein the encryption key is used to scramble physical layer modulation symbols.

5. The method of claim 4, wherein scrambling comprises applying modular offsets to Quadrature Amplitude Modulation (QAM) symbols.

6. The method of claim 3, wherein the encryption key is further used to modify OFDM sub-carrier assignment in a session-specific manner.

7. The method of claim 1, wherein the authentication challenge further comprises the UE's identity.

8. A system for secure wireless authentication, comprising:
a base station comprising:
one or more processors, and
a memory, the memory storing instructions that, when executed by the one or more processors, cause the base station to:
receive an attach request from a user equipment (UE), wherein the attach request includes a base station identity check comprising a request for an encrypted version of one or more historical wireless connection parameters shared between the UE and a wireless network of which the base station is part;
generate a first encrypted version of one or more historical wireless connection parameters previously shared with the UE during one or more past wireless connections with the wireless network;
generate an authentication request comprising the first encrypted version;
transmit the authentication request to the UE;
receive an authentication response from the UE, the authentication response comprising:
a second encrypted version of one or more additional historical wireless connection parameters;
a response code based on a shared secret authentication value;
validate the second encrypted version based on comparison with locally stored historical data;
validate the response code based on a locally computed value; and
authenticate the UE for wireless communication based on the validation of the second encrypted version and the response code.

9. The system of claim 8, wherein the base station is further configured to derive one or more encryption keys using the encrypted version and a session random value.

10. The system of claim 9, wherein the one or more encryption keys derived from the encrypted version are used to dynamically scramble modulation symbol mapping or to modify subcarrier allocation at a physical layer of a wireless communication link.

11. The system of claim 9, wherein the instructions stored in the memory further comprise instructions to select one of a plurality of encryption schemes to be applied during a communication session based on a stored policy or configuration.

12. The system of claim 9, wherein the one or more encryption keys are additionally used to derive a physical-layer integrity check value for detecting tampering during communication.

13. The system of claim 9, wherein the base station and network infrastructure is configured to update a security profile of the UE based on successful hash-based authentications over time, and to escalate authentication requirements if anomalous behavior is detected.

14. The system of claim 8, wherein the base station is configured to request a plurality of hashed values corresponding to distinct types of historical wireless connection data, and to verify the hashed values using a pre-defined sequence of authentication steps.

15. The system of claim 8, wherein the instructions stored in the memory further comprise instructions to implement a symmetric selection algorithm used by both the base station and the UE to determine which historical parameters to hash and exchange.

16. The system of claim 8, wherein the one or more processors are further configured to:
store historical connection metrics with corresponding timestamps;
apply an encrypted version function to a selected subset of the stored historical connection metrics; and
delete the selected subset after completion of an authentication process.

17. The system of claim 8, wherein the one or more processors are configured to reject authentication if any expected encrypted version is not received within a predefined time interval, thereby mitigating replay attacks.

18. The system of claim 8, wherein the base station and the UE are configured to apply an encrypted version function selected from the group consisting of Secure Hash Algorithm 256-bit (SHA-256), Secure Hash Algorithm 512-bit (SHA-512), Hash-Based Message Authentication Code (HMAC), or BLAKE3 to the historical wireless connection parameters.

19. A method performed by a user equipment (UE) for authenticating with a wireless network, the method comprising:
transmitting, to a base station, an attach request comprising a base station identity check, the identity check comprising a request for an encrypted version of one or more historical wireless connection parameters shared between the UE and a network of which the base station is part;
receiving, from a base station, an authentication request comprising a first encrypted version generated from one or more historical wireless connection parameters associated with the UE;
retrieving, at the UE, one or more locally stored historical wireless connection parameters;
verifying, at the UE, the first encrypted version based on the locally stored historical wireless connection parameters;
generating, at the UE, a second encrypted version of one or more additional historical wireless connection parameters in response to successful verification of the first encrypted version;
generating, at the UE, a response code based on a shared secret authentication value;
transmitting, to the base station, an authentication response comprising the second encrypted version and the response code; and
participating, at the UE, in a session establishment with the base station based on successful authentication validation.

20. The method of claim 19, further comprising verifying, at the UE, the first encrypted version included in the authentication request by comparing the first encrypted version with a locally computed hash based on the one or more locally stored historical wireless connection parameters.
